(19) United States
(12) Patent Application Publication
(10) Pub. No.: US 2026/0228506 A1
(43) Pub. Date: Aug. 6, 2026

(54) EFFECT DETECTION VIA CONVEX HULL SIMILARITY

(71) Applicant: Salesforce, Inc., San Francisco, CA (US)

(72) Inventors: Romain Cosentino, Palo Alto, CA (US); Sarath Shekkizhar, Seattle, WA (US); Yacov Salomon, Danville, CA (US)

(73) Assignee: Salesforce, Inc., San Francisco, CA (US)

(21) Appl. No.: 19/223,068

(22) Filed: May 30, 2025

Related U.S. Application Data
(60) Provisional application No. 63/752,627, filed on Jan. 31, 2025.

(51) Int. Cl. G06N 3/0475

(52) U.S. Cl. CPC G06N 3/0475

(57) ABSTRACT

An agent service can perform effect detection using a convex hull representation of an input. The agent service includes at least one agent large language model (LLM) trained to perform a plurality of tasks. A representation of the input is extracted from an attention layer of the at least one agent LLM. A value space representation is determined based on the extracted representation. A task is identified from the plurality of tasks to be performed by the agent based on the value space and an embedding corresponding to the task.

### CROSS-REFERENCE TO RELATED APPLICATIONS

This application claims the benefit of U.S. Provisional Application No. 63/752,627, filed Jan. 31, 2025, which is hereby incorporated by reference.

### TECHNICAL FIELD

One or more implementations relate to the field of large language models; and more specifically, to the effect detection via convex hull similarity.

### DESCRIPTION OF THE RELATED ART

The field of Artificial Intelligence (AI) focuses on the implementation of artificial neural network systems that aim to mimic the functionality of neurons in the brain. Machine learning is a sub-area of AI in which a machine learning model is trained to perform one or more specific tasks. For instance, a machine learning model can be trained to perform a target task by relying on patterns and inferences learned from training data, without requiring explicit instructions pertaining to how the task is to be performed.

Large language models (LLMs) are neural networks trained to mimic human language. Specifically, LLMs are trained to predict a next token of a block of text. In operation, LLMs track relationships in sequential data by receiving tokens (e.g., words in a sentence) and predicting a next token (or sequence of tokens). Accordingly, LLMs are well suited to form conversations (e.g., taking turns asking questions and providing responses) by predicting tokens (or sequences of tokens) that are tailored to the style and context of the conversation.

One of the challenges that one faces when dealing with a real-time agent is the capability of detecting the class (e.g., topic) to which a given input belongs. In an agent-based system, there can be input-dependent background information (such as tools and prompts) that needs to be extracted and sent to the agent to reason appropriately.

### BRIEF DESCRIPTION OF THE DRAWINGS

The following figures use like reference numbers to refer to like elements. Although the following figures depict various example implementations, alternative implementations are within the spirit and scope of the appended claims. In the drawings:

FIG. 1 is a block diagram illustrating an agent service using convex hull similarity according to some example implementations.

FIG. 2 is an alternative block diagram illustrating an agent service using convex hull similarity according to some example implementations.

FIG. 3A is a block diagram illustrating offline embedding processing according to some example implementations.

FIG. 3B is a block diagram illustrating offline convex hull processing according to some example implementations.

FIGS. 4A-4C illustrate examples of self-attention geometry according to some example implementations.

FIG. 5 is a flow diagram illustrating a technique for identifying task context information based on convex hull similarity according to some example implementations.

FIG. 6A is a block diagram illustrating an electronic device according to some example implementations.

FIG. 6B is a block diagram of a deployment environment according to some example implementations.

### DETAILED DESCRIPTION

The following description describes implementations for using convex hull similarity to identify appropriate task context data in an agent-based system. Agent-based systems typically rely on input-dependent information that needs to get extracted and sent to the agent to reason appropriately. For example, in a conversation between a customer and an agent, the agent has access to various documents, configurations, and flows that can be used to best answer the customer request. Depending on the customer input, the right documents, configurations, or flows need to be extracted and used by the agent to respond to the customer input. However, a given agent may be capable of performing a number of different tasks, and the task data (e.g., documents, configurations, flows, etc.) available to the agent may cover all of the different tasks. As such, not all of the task data is needed to respond to the customer, instead only the relevant tasks data needs to be retrieved. Additionally, as the agent is conversational, the retrieval needs to be performed in real-time to avoid latency which leads to a poor user experience.

Prior attempts to address this problem have used retrieval augmented generation (RAG) systems. Such systems perform an embedding extraction over some database of documents, and upon receipt of the customer input generate a corresponding embedding. This input embedding can then be compared to the embeddings of the database of documents using a similarity score. The most similar document is then provided to the agent prompt allowing it to reason as to best answer the customer input.

Existing techniques require that the input and the content of the task data (e.g., document/flow/config etc.) be semantically aligned. Unfortunately, in practice, often the customer utterance is not directly aligned with the existing task data. However, the input can be thought of as “causing” the doc/config/flow. That is, given a cause, i.e., the customer input, which effect needs to be used? This is referred to herein as “effect detection” and enables the appropriate task data to be identified more efficiently than prior techniques. Some embodiments are discussed herein with respect to customer support LLM agents, this is for simplicity of explanation and is not intended to be limiting. Embodiments may be applied to any causal relationship detection.

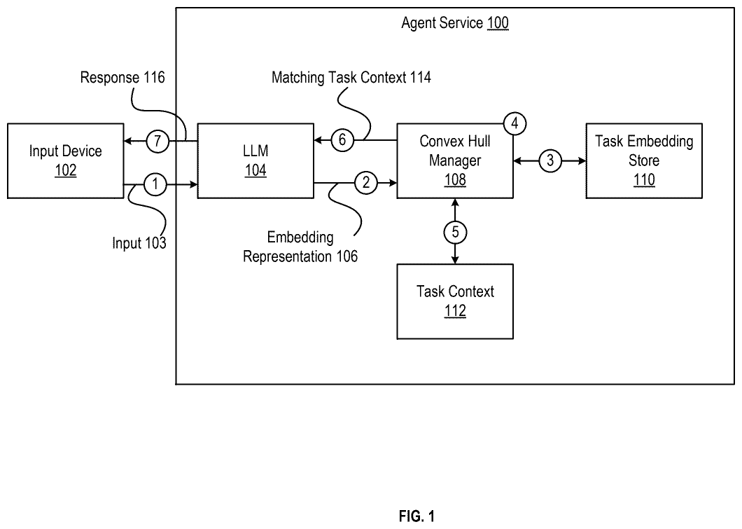

FIG. 1 is a block diagram illustrating an agent service using convex hull similarity according to some example implementations. As shown in FIG. 1, a user can interact with agent service 100 via input device 102. The input device can include a user device, such as a smartphone, laptop, desktop, etc. The agent service can be implemented in a cloud computing environment and may communicate with the input device over one or more networks, such as the internet. In some implementations, the agent service 100 may be implemented on a computing device, such as a computing device at a customer location and/or implemented over a private network.

A user can provide an input to the agent service 100 using input device 102. The agent service 100 can include one or more large language models (LLMs) 104 which act as agents responding to inputs. A given agent LLM may be capable of performing multiple tasks. For example, LLM 104 may have access to two flows. Each flow includes a sequence of actions the agent LLM would perform depending on the case. Depending on the input, one of these flows may be identified and the appropriate task context 112 can be provided to the agent LLM to respond to the user input. In one example, Flow 1 is a hotel cancellation flow, e.g., the flow requests a reservation number, performs an API call to check if a corresponding reservation exists, and removes the reservation from a reservation database. In this example, Flow 2 may be a room service flow, e.g., the flow requests a room number and preferred hour of room service, then makes an API call to set up the room service order.

When an input is received, the agent service 100 needs to determine whether to retrieve task data for Flow 1 vs Flow 2 based on the input 103. However, the utterance “I want to cancel my booking” might not semantically align with any of these flows. This may be due to the expected utterance to be in a specific format, etc. In fact, only semantically similar sentences can be captured by a RAG approach. Concretely, computing the similarity between Flow1/Flow2 with the embedding utterance will not give accurate and robust results.

Instead, various implementations overcome the deficiencies of prior systems by detecting whether the input has the same “effect” as one of the flows. (e.g., to detect that “I want to cancel my booking” has the “effect” of Flow 1). Implementations rely on the geometry of LLMs (Large Language Models). In particular, because LLMs were pre-trained on universal data, they have the intrinsic notions of the effect when given a cause. Below is an example generated using an example agent:
Agent Input: You're a hotel booking agent, behave as such. //task data
Customer: Hey I want to cancel my booking . . . //user input
Agent Response: Of course! I can assist you with that. Could you please provide me with your booking reference number or the details of your reservation, such as the name it was made under and the date of your stay? This will help me locate your booking quickly. //response based on task data and user input

As such, if one computes a similarity between the response and the task data, that would be more robust and accurate than just sending the input. However, this would further require the following steps: (i) sending the input to an LLM, (ii) letting the LLM generate K number of tokens, (iii) computing the embedding of the LLM generated output, and (iv) computing similarity between the latter and the task document embeddings.

This process is therefore long and expensive. Instead, implementations remove step (ii). That is, the generation step. In fact, after step (i), implementations extract from the LLM a representation of its future state. From this representation, a similarity is computed with the input. This approach enables a match to be identified without requiring a full pass by the LLM on the input, enabling the appropriate task context to be quickly and efficiently to be identified.

Implementations capture the future state of an LLM based on the geometry of LLMs. In particular, the output of one or more attention layers of an LLM lies in the convex hull of the input to the LLM. Concretely, it means that, given (x₁, . . . , x_{T}) as T input tokens, the output of the attention layer can be represented as:

$${LLM}_{attention} ( {x}_{T + 1} ) ∈ ConvexHull ( {LLM}_{attention} ( {x}_{1} , … , {x}_{T} ) ) \qquad 1$$

where the convex hull of T elements is defined as the space covering all the convex combination of T elements.

As such, given an input sentence, the value space that the LLM will be predicting upon is known. This geometrical analysis provides access to a representation of the future LLM generation.

In some implementations, the goal is to be able to capture the future prediction of the LLM, that is assumed to capture the “effect” of the input, i.e., the cause, and therefore align with the appropriate task data. In one implementation, as shown in FIG. 1, at numeral 1, the input 103 is received by LLM 104. As discussed, this input may be a utterance (e.g., voice data), text input, image data, or other modalities. In some implementations, the LLM may be a multi-modal model which can receive multi-modal data including text, images, audio, etc.

In some implementations, the embedding corresponding to the input 103 is then extracted. For example, in some implementations the input 103 can be tokenized. An embedding representation 106 can be extracted from one or more attention layers of the agent LLM. This can be provided to convex hull manager 108 at numeral 2. Convex hull manager 108 can retrieve previously stored embeddings corresponding to the available tasks that the agent can perform from task embedding store 110, as shown at numeral 3. Convex hull manager 108 can then compute the convex hull representation at numeral 4.

In some implementations, for each docs/config/flow embedding (e.g., task data), a distribution of how close each task data is to the convex hull is then computed. This can be a similarity measure, a probabilistic one, a Boolean saying if it does lie into the convex hull etc. The closest task data is then retrieved from task context 112 at numeral 5. This matching task context 114 can then be returned to the LLM at numeral 6, where it is used to process the input 103 and generate a response 116. The response is then returned to the user via input device 102 at numeral 7.

In some implementations, to evaluate the closeness between the effects and the cause convex hull, multiple approaches can be considered. In one example, assume that the effect “prompt” is defined by K tokens, [x₁, . . . , x_{K}]. The output of a self-attention layer, e.g., [u₁, . . . , u_{K}]=LLMₐₜₜₑₙₜᵢₒₙ(x₁, . . . , x_{K}), is also a matrix of dimension d×K.

In some implementations ∇i∈[1, . . . , K] can be computed if uᵢ is in the convex hull of the cause. That is, for each vector uᵢ a Boolean value is obtained which indicates if the vector is inside the convex hull or not. This can be done efficiently by finding a feasible point of a Linear Program. This is a Linear Programing problem that can be solved efficiently.

Alternatively, in some implementations, if uᵢ does not fall within the convex hull of the cause, the distance between the closest point of vector uᵢ and the convex hull can be determined. Then, first order statistics are computed across the token dimension to recover a scalar value enabling comparisons between each task and the input representation. In some implementations, this approach can be derived to any weighted similarity computation for each u; and then taking an average.

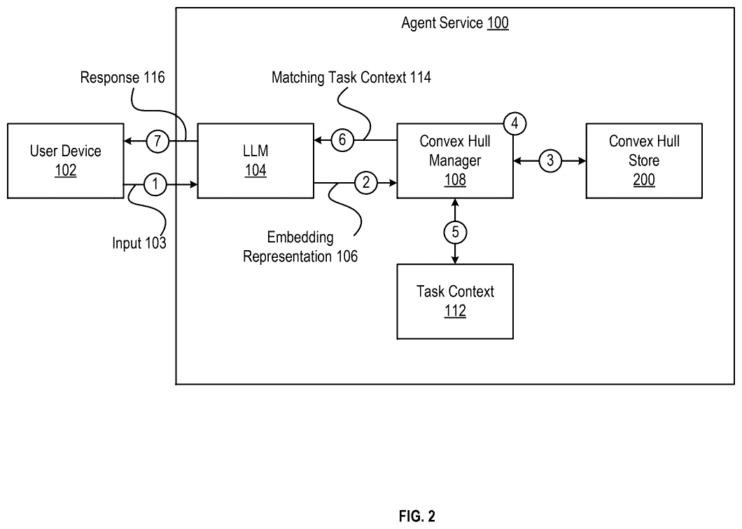

FIG. 2 is an alternative block diagram illustrating an agent service using convex hull similarity according to some example implementations. The example of FIG. 2 shows a similar approach which includes performing the above-described operations in a dual space. That is, instead of looking at the “cause” convex hull, implementations look at the dual space of the “effect” convex hull. For example, at numeral 1, the “cause” input 103 is provided to the agent LLM 104. The embedding representation 106 is extracted from the one or more attention layers as before. Convex hull manager can then compute a distribution of how much this embedding representation is close to the convex hulls in convex hull store 200. Convex hull store 200 includes convex hulls that were computed offline for each possible “effect” that the LLM is capable of providing. When computed offline, to be in a dual space, the effect is pre-pended to the prompt, such as “What cause or input would lead to the following flow/config/document”. The closest task data can then be retrieved from task context 112 and provided to LLM 104.

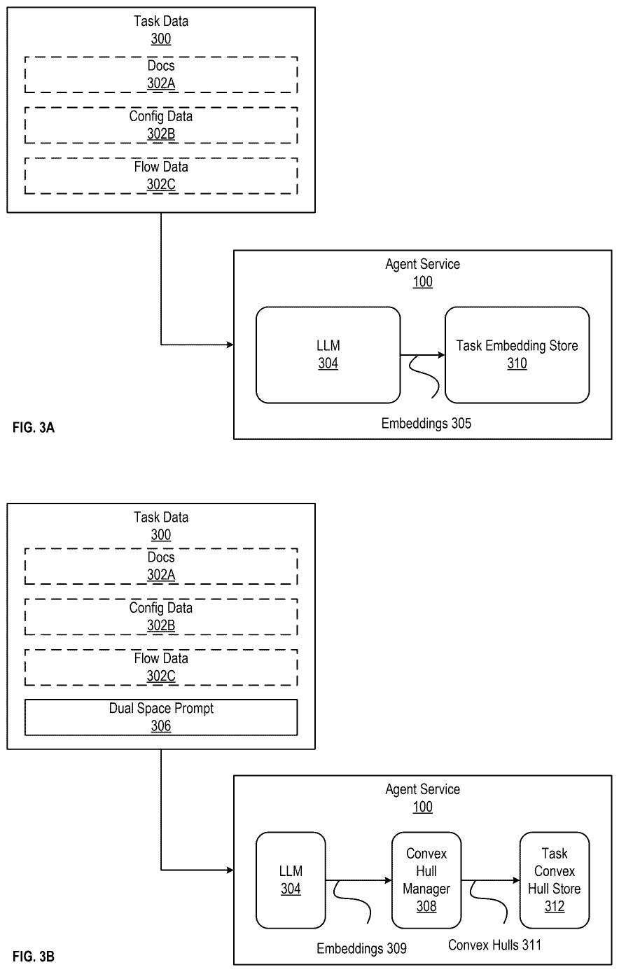

FIG. 3A is a block diagram illustrating offline embedding processing according to some example implementations. As discussed, task embeddings can be computed offline by the agent service 100. For example, at design time, the agent service 100 can receive task data 300, such as documents 302A, configuration data 302B, flow data 302C, etc. These can be processed by LLM 304 to generate corresponding embeddings. In some embodiments, LLM 304 can be the same LLM as the LLM agent deployed at run time. The embeddings can then be stored in task embedding store 310 where they can be used at runtime as discussed above.

FIG. 3B is a block diagram illustrating offline convex hull processing according to some example implementations. In some implementations, the agent service 100 can receive task data 300, such as documents 302A, configuration data 302B, flow data 302C, etc. along with a dual space prompt 306 (e.g., “Give the potential input that will trigger such a doc/config/flow”). These can be processed by LLM 304 to generate corresponding embeddings 309. Using the embeddings 309, convex hull manager 308 can compute the convex hull representation 311 for each task data. In some embodiments, LLM 304 can be the same LLM as the LLM agent deployed at run time. The convex hulls can then be stored in task convex hull store 312 where they can be used at runtime as discussed above.

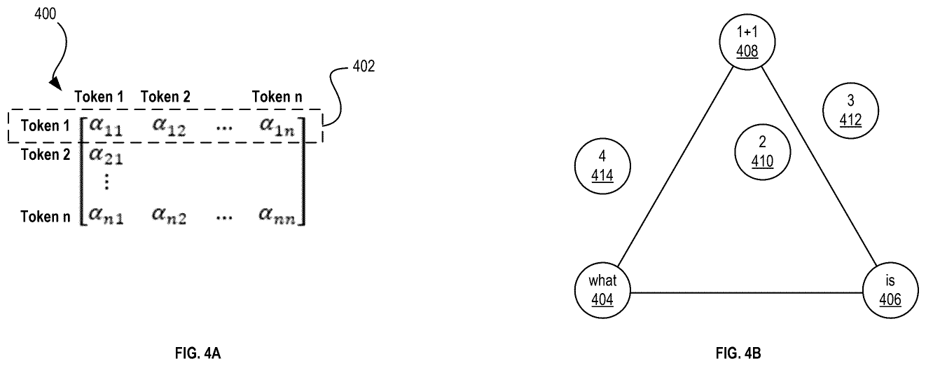

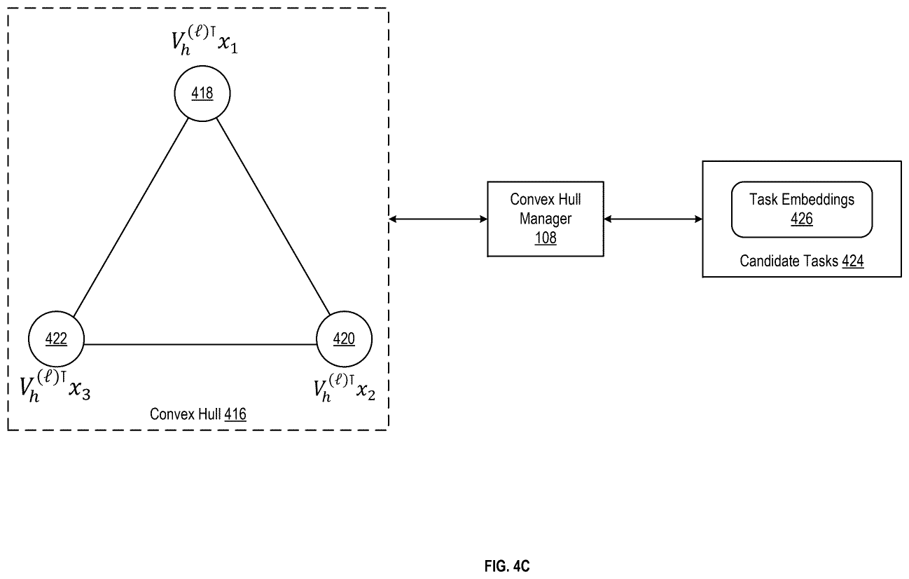

FIGS. 4A-4C illustrate an example of self-attention geometry according to some example implementations. As discussed, given an input to an LLM, embodiments can determine what set of stored data is related to that input. For example, the LLM may be trained to perform several tasks. When a user input is received, the task associated with that input needs to be determined so that additional context data can be provided to the LLM to enable it to perform the desired task based on the user input. This can be phrased as “cause” and “effect,” where the “cause” is the user input, and the “effect” is the task to be performed. As discussed, prior systems would require a task detection step that involves additional calls to an LLM to determine the task associated with the user input, followed by retrieval of stored task data, and then calls to the LLM that will perform the task based on the user input and the stored task data. However, this introduces the costs of additional LLM calls as well as latency associated with those calls which can lead to a poor user experience. Instead, the task can be identified based on a self-attention layer of the LLM, without requiring additional LLM processing.

The self-attention layer can be represented as a matrix, as shown in FIG. 4A. Matrix 400 indicates how connected tokens 1-n are to one another. For example, each matrix value a may be a similarity value calculated between the tokens. In some embodiments, a single-head mapping of X can be represented as:

$${Head}_{h} {=}^{Δ} {softmax}_{causal} ( {{XQ}_{h} ( {XK}_{h} )}^{T} ) {XV}_{h} \qquad 2$$

In particular, X represents the input data (e.g., a matrix of dimension ‘number of tokens’×‘hidden dimension’), Qₕ represents the query embedding matrix, Kₕ represents the key embedding matrix, and Vₕ represents the value embedding matrix. In this example, the first term, softmax causal (XQₕ(XKₕ)^{T}), corresponds to the matrix 400 and the second term, XVₕ, corresponds to an embedding in value space Vn. For example, considering a single token i, α=softmax_{causal}(XQₕ(XKₕ)^{T}) [i, :]. This corresponds to one row of matrix 400. For example, where i=1, this corresponds to row 402. Because of the softmax function, the sum of elements in a given vector (e.g., row of matrix 400) is equal to one. This can be represented as:

$${Head}_{h} ( [ X ) i , : ] = {\sum }_{j = 1}^{i} {α}_{j} \times {V}_{h}^{T} {x}_{j} , \qquad 3$$

$$s . t . : {\sum }_{j = 1}^{i} {α}_{j} = 1$$

The i^{th} row of the h^{th} head mapping output Headₕ(X) lies within the convex hull, Hull {(Vₕ)^{T}xⱼ, j=1, . . . , i}, and is of effective dimension at most #{Attnₕ( [symbol] )_{i,j}>0, j={1, 2, . . . , i}}.

Accordingly, the output of a head for a single token is the convex combination of the embeddings in the value space. As a result, the output (e.g., the next token) will be within the convex hull of the previous tokens. As shown in FIG. 4B, given a simple input “cause” of “what is 1+1?”, this can be tokenized into “what” 404, “is” 406, and “1+1” 408. Since there are three tokens, the convex hull is a triangle within which the answer (e.g., the “effect”) must appear. However, given more complex “causes” with more tokens, the convex hull may take the form of other closed shapes formed from the intersections of the embeddings of the tokens in value space Vn. As discussed, the stored embeddings corresponding to “effects” can be compared to the convex hull to determine the task associated with the input. In this example, stored embeddings correspond to “2” 410, “3” 412, and “4” 414. The embedding for “2” 410 falls within the convex hull, as shown, and is the effect.

This can be generalized as shown in FIG. 4C. As discussed, the user input, input documents, or other input data may be provided to an LLM. This input is tokenized, and corresponding embeddings can be extracted from one or more self-attention layers of the LLM. LLMs operated by predicting a next token from a series of input tokens. In this example, the embedding representations of input tokens 418-420 in a value space form a convex hull 416. Although three tokens are shown resulting in a triangle, in various embodiments more tokens may be received resulting in different shaped convex hulls. Additionally, the value space may be a high-dimensional space and the resulting convex hull may encompass a higher-dimensional space than that depicted in FIG. 4C. The example of FIG. 4C has been shown for ease of depiction and description and is not intended to be limiting.

As discussed above with respect to equation 3, for a single token, the output of the i^{th} token is the convex combination of the input token embeddings. This requires then, that the output (e.g., the next token) will be within the convex hull of the vector defined by

$${V}_{h}^{T} {x}_{j} ,$$

e.g., as described at least with respect to equation 1. Therefore, convex hull manager 108 determine a candidate task 424 which the LLM has been trained to perform, by comparing the task embeddings 426 to the convex hull 416. For example, the task embedding that falls within the convex hull may be determined to correspond to the task needed to process the input. Alternatively, the task that is closest to the convex hull, if no task falls within the convex hull, can be determined to correspond to the task needed to process the input. Similarly, as discussed above, offline candidate convex hulls may be used to identify the task being invoked.

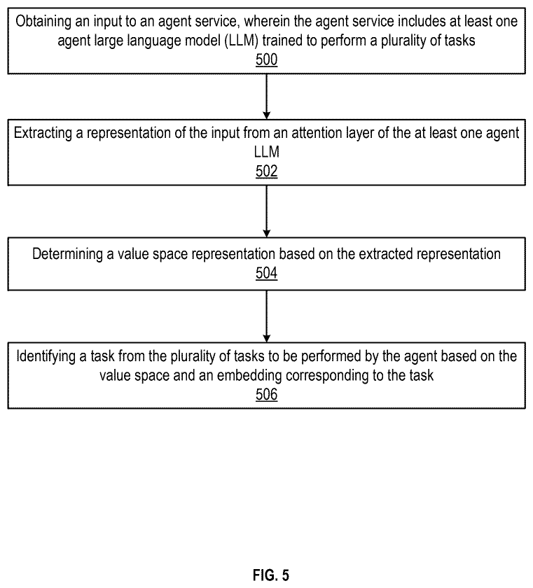

FIG. 5 is a flow diagram illustrating a technique for identifying task context information based on convex hull similarity according to some example implementations. In one or more implementations, the method is performed in a digital medium environment that includes the agent service 100.

As illustrated in FIG. 5, the method includes an act 500 of obtaining an input to a agent service, wherein the agent service includes at least one agent large language model (LLM) trained to perform a plurality of tasks. In various embodiments, the agent service may include a multi-modal LLM which is capable of receiving and processing various forms of inputs (e.g., text, image, audio, etc.).

As illustrated in FIG. 5, the method also includes an act 502 of extracting a representation of the input from an attention layer of the at least one agent LLM. As discussed, in various embodiments, the agent LLM can tokenize the input and compute embedding representations of each token. The LLM can include an attention layer from which the representation of the input can be extracted. This representation may include a vector of values including embedding representations of the tokens combined with similarity values, where the sum of similarity values equals one.

As illustrated in FIG. 5, the method also includes an act 504 of determining a value space representation based on the extracted representation. In some embodiments, the value space representation includes a convex hull formed from the embedding representations within the value space. Due to the architecture of LLMs, the output of the LLM will fall within the convex hull, as discussed.

As illustrated in FIG. 5, the method also includes an act 506 of identifying a task from the plurality of tasks to be performed by the agent based on the value space and an embedding corresponding to the task. For example, embedding representations of the tasks may be computed offline. These embedding representations can be compared to the convex hull and the representation that falls within the convex hull, or nearest to the convex hull, corresponds to the task to be performed by the agent.

In some implementations, the method further includes retrieving a context associated with the task; and providing the context associated with the task to the agent LLM. In some implementations, the method further includes generating, by the agent LLM, a response based at least on the input and the context associated with task. In some implementations, the value space is defined by a convex hull computed from the extracted representation. In some implementations, the convex hull is computed based at least on embeddings corresponding to a plurality of tokens of the input extracted from an attention layer of the agent LLM. In some implementations, the extracted representation is compared to embeddings computed offline corresponding to the plurality of tasks. In some implementations, the extracted representation is compared to convex hulls computed offline corresponding to the plurality of tasks.

### Example Electronic Devices and Environments

### Electronic Device and Machine-Readable Media

One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, machine, etc.) includes hardware and software. For example, an electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals-such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

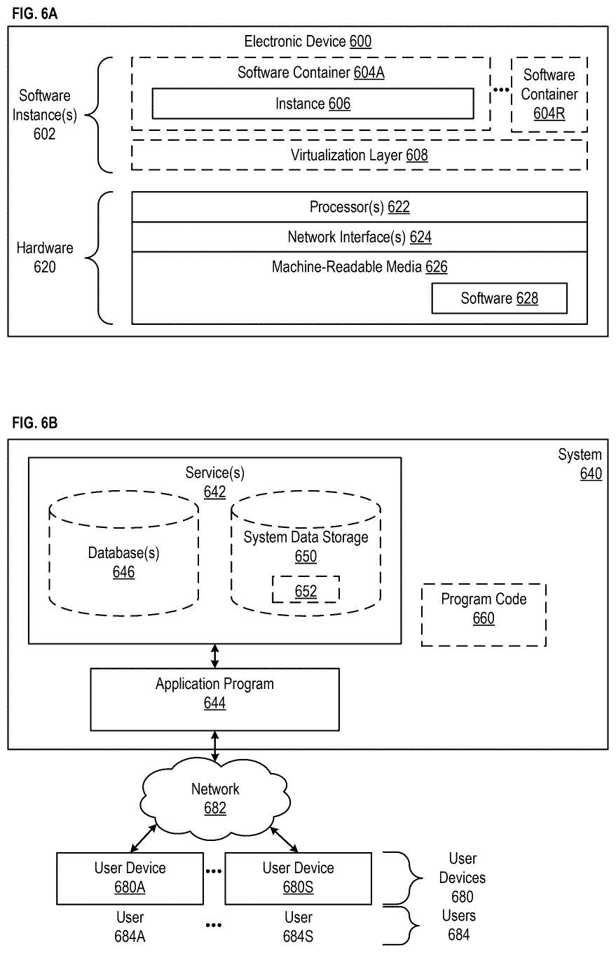

FIG. 6A is a block diagram illustrating an electronic device 600 according to some example implementations. FIG. 6A includes hardware 620 comprising a set of one or more processor(s) 622, a set of one or more network interfaces 624 (wireless and/or wired), and machine-readable media 626 having stored therein software 628 (which includes instructions executable by the set of one or more processor(s) 622). The machine-readable media 626 may include non-transitory and/or transitory machine-readable media. Each of the previously described clients and the agent service may be implemented in one or more of electronic device 600. In one implementation: 1) each of the clients is implemented in a separate one of the electronic device 600 (e.g., in end user devices where the software 628 represents the software to implement clients to interface directly and/or indirectly with the agent service (e.g., software 628 represents a web browser, a native client, a portal, a command-line interface, and/or an application programming interface (API) based upon protocols such as Simple Object Access Protocol (SOAP), Representational State Transfer (REST), etc.)); 2) the agent service is implemented in a separate set of one or more of electronic device 600 (e.g., a set of one or more server devices where the software 628 represents the software to implement the agent service); and 6) in operation, the electronic devices implementing the clients and the agent service would be communicatively coupled (e.g., by a network) and would establish between them (or through one or more other layers and/or or other services) connections for submitting user input to the agent service and returning agent responses to the clients. Other configurations of electronic devices may be used in other implementations (e.g., an implementation in which the client and the agent service are implemented on a single one of electronic device 600).

During operation, an instance of the software 628 (illustrated as instance 606 and referred to as a software instance; and in the more specific case of an application, as an application instance) is executed. In electronic devices that use compute virtualization, the set of one or more processor(s) 622 typically execute software to instantiate a virtualization layer 608 and a set of one or more software containers, shown as software container 604A to software container 604R (e.g., with operating system-level virtualization, the virtualization layer 608 may represent a container engine (such as Docker® Engine container runtime by Docker, Inc. or Red Hat® OpenShift container runtime by Red Hat, Inc.) running on top of (or integrated into) an operating system, and it allows for the creation of multiple software containers (representing separate user space instances and also called virtualization engines, virtual private servers, or jails) that may each be used to execute a set of one or more applications; with full virtualization, the virtualization layer 608 represents a hypervisor (sometimes referred to as a virtual machine monitor (VMM)) or a hypervisor executing on top of a host operating system, and the software containers each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 628 is executed within the software container 604A on the virtualization layer 608. In electronic devices where compute virtualization is not used, the instance 606 on top of a host operating system is executed on the “bare metal” electronic device 600. Instances of the software 628, as well as the virtualization layer 608 and the software containers if implemented, are collectively referred to as software instance(s) 602.

Alternative implementations of an electronic device may have numerous variations from that described above. For example, customized hardware and/or accelerators might also be used in an electronic device.

### Example Environment

FIG. 6B is a block diagram of a deployment environment according to some example implementations. A system 640 includes hardware (e.g., a set of one or more server devices) and software to provide service(s) 642, including the agent service. In some implementations the system 640 is in one or more datacenter(s). These datacenter(s) may be: 1) first party datacenter(s), which are datacenter(s) owned and/or operated by the same entity that provides and/or operates some or all of the software that provides the service(s) 642; and/or 2) third-party datacenter(s), which are datacenter(s) owned and/or operated by one or more different entities than the entity that provides the service(s) 642 (e.g., the different entities may host some or all of the software provided and/or operated by the entity that provides the service(s) 642). For example, third-party datacenters may be owned and/or operated by entities providing public cloud services (e.g., Amazon Web Services® service by Amazon.com, Inc., Google Cloud Platform™ service by Google LLC, Azure® service by Microsoft Corporation).

The system 640 is coupled to user devices 680 (shown as user device 680A to user device 680S) over a network 682. The service(s) 642 may be on-demand services that are made available to users 684 (shown as user 684A to user 684S) working for one or more entities other than the entity which owns and/or operates the on-demand services (those users sometimes referred to as outside users) so that those entities need not be concerned with building and/or maintaining a system, but instead may make use of the service(s) 642 when needed (e.g., when needed by the users). The service(s) 642 may communicate with each other and/or with one or more of the user devices 680 via one or more APIs (e.g., a REST API). In some implementations, the user devices 680 are operated by the users 684, and each may be operated as a client device and/or a server device. In some implementations, one or more of the user devices 680 are separate ones of the electronic device 600 or include one or more features of the electronic device 600.

In some implementations, the system 640 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant typically includes a group of users with access to at least some of the same data/functionality with the same or similar privileges/permissions. Tenants may be different entities (e.g., different companies, different departments/divisions of a company, and/or other types of entities), and some or all these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all the vendors' data. As another example, in the context of Platform as a Service (PAAS), one set of tenants may be third-party application developers providing applications/services and another set of tenants may be customers of different ones or all the third-party application developers.

Multi-tenancy can be implemented in different ways. In some implementations, a multi-tenant architecture may include software instance(s) that are shared by multiple tenants (e.g., a single database instance share by multiple tenants, sometime referred to as a multi-tenant database; a single application instance shared by multiple tenants, sometimes referred to as a multi-tenant application; a single application instance and a single database instance shared by multiple tenants; an application instance per tenant and a database instance shared by multiple tenants; a single application instance share by multiple tenants and a database instance per tenant).

In one implementation, the system 640 is a multi-tenant cloud computing architecture supporting multiple services, such as one or more of the following types of services: Customer relationship management (CRM); Configure, price, quote (CPQ); Business process modeling (BPM); Customer support; Marketing; External data connectivity; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Analytics; Community; Internet-of-Things (IoT); Industry-specific; Artificial intelligence (AI); Application marketplace (“app store”); Data modeling; Security; and Identity and access management (IAM).

For example, system 640 may include an application platform 644 that enables PAAS for creating, managing, and executing one or more applications developed by the provider of the application platform 644, users accessing the system 640 via one or more of the user devices 680, or third-party application developers accessing the system 640 via one or more of user devices 680.

In some implementations, one or more of the service(s) 642 may use one or more database(s) 646 and/or system data storage 650 (which stores system data 652). In certain implementations, the system 640 includes a set of one or more servers that are running on server electronic devices and that are configured to handle requests for any authorized user associated with any tenant (there is no server affinity for a user and/or tenant to a specific server). The user devices 680 communicate with the server(s) of system 640 to request and update tenant-level data and system-level data hosted by system 640, and in response the system 640 (e.g., one or more servers in system 640) automatically may generate one or more Structured Query Language (SQL) statements (e.g., one or more SQL queries) that are designed to access the desired information from the database(s) 646 and/or system data storage 650.

In some implementations, the service(s) 642 are implemented using virtual applications dynamically created at run time responsive to queries from the user devices 680 and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 660 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 644 includes an application setup mechanism that supports application developers' creation and management of applications, which may be saved as metadata by save routines. Invocations to such applications, including the agent service, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 682 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 6rd Generation Partnership Project (3GPP) protocol, a 4th generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 640 and the user devices 680.

Each of the user devices 680 (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 640. For example, the user interface device can be used to access data and applications hosted by system 640, and to perform searches on stored data, and otherwise allow one or more of users 684 to interact with various GUI pages that may be presented to the one or more of users 684. The user devices 680 may communicate with system 640 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more the user devices 680 may include an HTTP client, commonly referred to as a “browser,” for sending and receiving HTTP messages to and from server(s) of system 640, thus allowing one or more of the users 684 to access, process and view information, pages and applications available from system 640 over network 682.

### CONCLUSION

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting.

What is claimed is:

1. A non-transitory machine-readable storage medium that provides instructions that, if executed by a processor, are configurable to cause the processor to perform operations comprising:
obtaining an input to a agent service, wherein the agent service includes at least one agent large language model (LLM) trained to perform a plurality of tasks;
extracting a representation of the input from an attention layer of the at least one agent LLM;
determining a value space representation based on the extracted representation; and
identifying a task from the plurality of tasks to be performed by the agent LLM based on the value space representation and an embedding corresponding to the task.

2. The non-transitory machine-readable storage medium of claim 1, wherein the operations further comprise:
retrieving a context associated with the task; and
providing the context associated with the task to the agent LLM.

3. The non-transitory machine-readable storage medium of claim 2, wherein the operations further comprise:
generating, by the agent LLM, a response based at least on the input and the context associated with task.

4. The non-transitory machine-readable storage medium of claim 1, wherein the value space representation is defined by a convex hull computed from the extracted representation.

5. The non-transitory machine-readable storage medium of claim 4, wherein the convex hull is computed based at least on embeddings corresponding to a plurality of tokens of the input extracted from an attention layer of the agent LLM.

6. The non-transitory machine-readable storage medium of claim 1, wherein the extracted representation is compared to embeddings computed offline corresponding to the plurality of tasks.

7. The non-transitory machine-readable storage medium of claim 1, wherein the extracted representation is compared to convex hulls computed offline corresponding to the plurality of tasks.

8. A method comprising:
obtaining an input to a agent service, wherein the agent service includes at least one agent large language model (LLM) trained to perform a plurality of tasks;
extracting a representation of the input from an attention layer of the at least one agent LLM;
determining a value space representation based on the extracted representation; and
identifying a task from the plurality of tasks to be performed by the agent LLM based on the value space representation and an embedding corresponding to the task.

9. The method of claim 8, further comprising:
retrieving a context associated with the task; and
providing the context associated with the task to the agent LLM.

10. The method of claim 9, further comprising:
generating, by the agent LLM, a response based at least on the input and the context associated with task.

11. The method of claim 8, wherein the value space representation is defined by a convex hull computed from the extracted representation.

12. The method of claim 11, wherein the convex hull is computed based at least on embeddings corresponding to a plurality of tokens of the input extracted from an attention layer of the agent LLM.

13. The method of claim 8, wherein the extracted representation is compared to embeddings computed offline corresponding to the plurality of tasks.

14. The method of claim 8, wherein the extracted representation is compared to convex hulls computed offline corresponding to the plurality of tasks.

15. An apparatus comprising:
a processor; and
a non-transitory machine-readable storage medium that provides instructions that, if executed by the processor, are configurable to cause the apparatus to perform operations comprising,
obtaining an input to a agent service, wherein the agent service includes at least one agent large language model (LLM) trained to perform a plurality of tasks;
extracting a representation of the input from an attention layer of the at least one agent LLM;
determining a value space representation based on the extracted representation; and
identifying a task from the plurality of tasks to be performed by the agent LLM based on the value space representation and an embedding corresponding to the task.

16. The apparatus of claim 15, wherein the operations further comprise:
retrieving a context associated with the task; and
providing the context associated with the task to the agent LLM.

17. The apparatus of claim 16, wherein the operations further comprise:
generating, by the agent LLM, a response based at least on the input and the context associated with task.

18. The apparatus of claim 15, wherein the value space representation is defined by a convex hull computed from the extracted representation.

19. The apparatus of claim 18, wherein the convex hull is computed based at least on embeddings corresponding to a plurality of tokens of the input extracted from an attention layer of the agent LLM.

20. The apparatus of claim 15, wherein the extracted representation is compared to embeddings computed offline corresponding to the plurality of tasks.
